(19) United States
(12) Patent Application Publication
(10) Pub. No.: US 2004/0115326 A1
(43) Pub. Date: Jun. 17, 2004

(54) System and method for creating a flavor formula

(76) Inventor: Richard F. Heinze, St. Louis, MO (US)

Correspondence Address: David R. Deal, Thompson Coburn LLP, One US Bank Plaza, St. Louis, MO, 63101-9928, US

(21) Appl. No.: 10/704,466

(22) Filed: Nov. 7, 2003

Related U.S. Application Data
(60) Provisional application No. 60/424,640, filed on Nov. 7, 2002.

(51) Int. Cl. A23L 1/22

(52) U.S. Cl. 426/534

(57) ABSTRACT

A method of creating a specific flavor formula using a flavor creation system. The method includes the steps of selecting a flavor from stored general flavors, displaying an ingredient associated by a flavor association with the selected flavor, displaying a sensory property associated by a sensory association with the displayed ingredient; and inputting a use level of the ingredient.

This is a non-provisional application based on provisional application Ser. No. 60/424,640, filed Nov. 7, 2002, for which priority is claimed.

### SUMMARY OF THE INVENTION

One aspect of the present invention is a system for creating a flavor formula. The flavor formula includes amounts of flavor ingredients to be dissolved in a solvent to create a flavor. The system includes a processor, an input device, a display device and a computer readable medium. The input device is in communication with the processor and is configured to input user data from a user to the processor. The display device is in communication with the processor and is configured to be responsive to the processor to display images thereon. The computer readable medium has one or more instructions executable by the processor for storing data. The data comprises: data corresponding to an ingredient; data corresponding to a plurality of general flavors; data corresponding to a flavor association of at least one of the stored general flavors with at least one of the stored ingredients, the flavor association data being created in response to user input; data corresponding to a sensory association of at least one sensory property with at least one stored ingredient, the sensory property including a quantitative component and a qualitative component and being created in response to user input. The computer readable medium also has instructions for obtaining user input corresponding to a selection of at least one of the stored general flavors, and for displaying on the display device at least one ingredient associated with the flavor selection based on the stored flavor association, and for displaying on the display device the stored sensory property for the displayed ingredient.

Another aspect of the present invention is a method of creating a specific flavor formula using a flavor creation system. The method includes the steps of selecting a flavor from stored flavors, displaying an ingredient associated by a flavor association with the selected flavor, displaying a sensory property associated by a sensory association with the displayed ingredient, and inputting a use level of the ingredient.

Another aspect of the present invention is a method of selecting an input level of an ingredient in a flavor formula. The method includes the steps of displaying a sensory property of the ingredient and using the sensory property of the ingredient to determine the input level of the ingredient in the flavor formula. The sensory property includes at least one of a qualitative component and a quantitative component;

Other features and advantages will be in part apparent and in part pointed out hereinafter.

### BRIEF DESCRIPTION OF THE DRAWINGS

FIG. 1 is a schematic representation of a system according to the invention;

FIG. 2 is a specific flavor formula created using the system of FIG. 1;

FIG. 3 is an ingredient screen generated by an embodiment of the system of FIG. 1;

FIG. 4 a descriptor screen generated by an embodiment of the system of FIG. 1;

FIG. 5 is a flavor screen generated by an embodiment of the system of FIG. 1;

FIG. 6 is a flavor association screen generated by an embodiment of the system of FIG. 1;

FIG. 7 is a sensory association screen generated by an embodiment of the system of FIG. 1;

FIGS. 8a and 8b are representations of the system of FIG. 1 in use.

Corresponding reference characters indicate corresponding parts throughout the several views of the drawings.

### DETAILED DESCRIPTION OF THE PREFERRED EMBODIMENTS

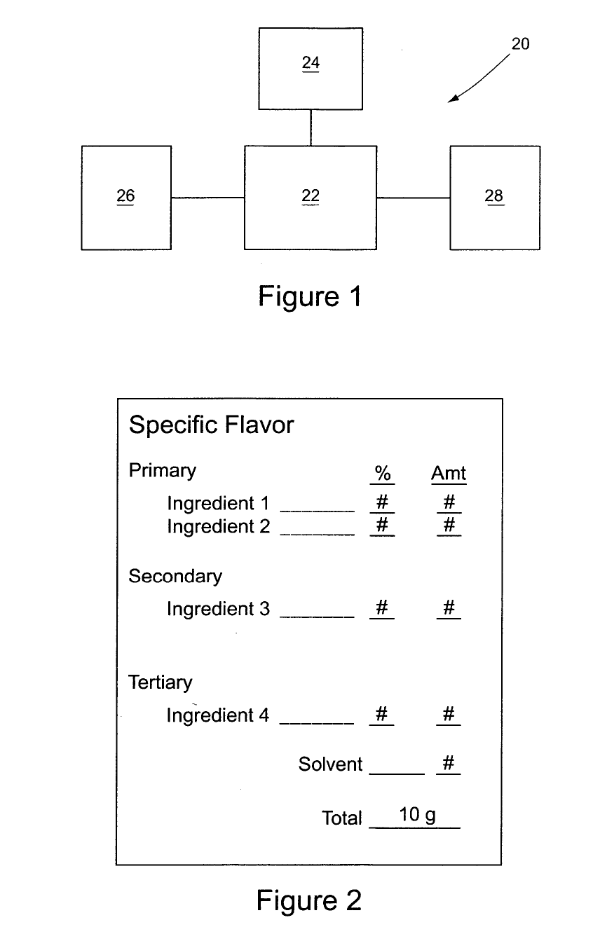

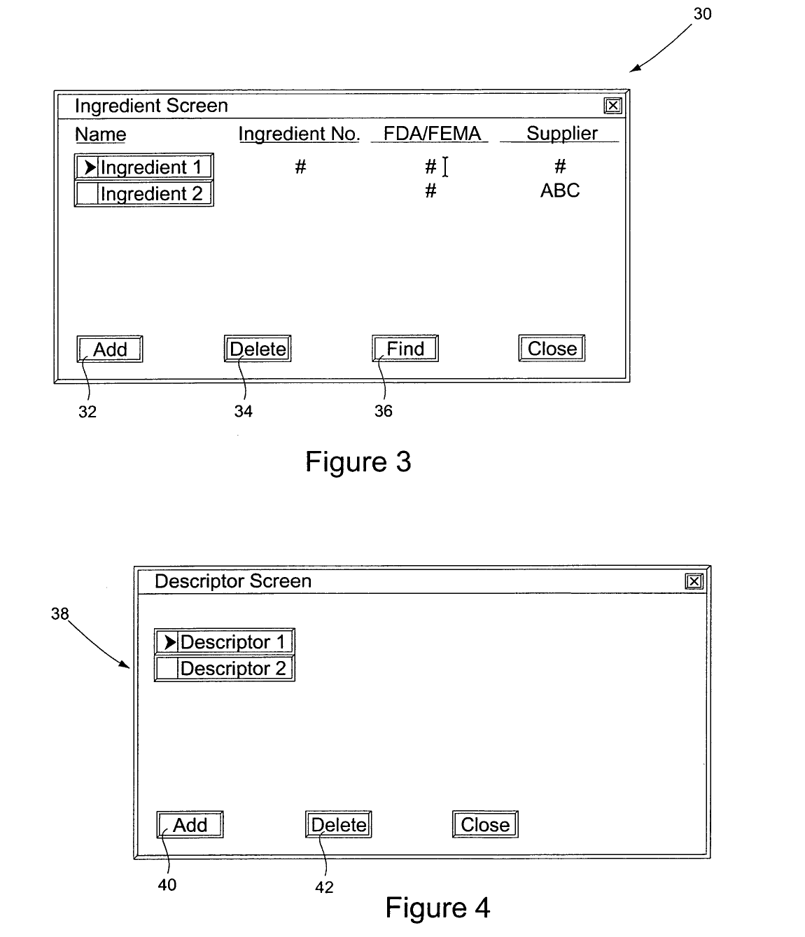

Referring now to the drawings, and more particularly to FIG. 1, a system according to the present invention is shown generally at 20. The system is depicted schematically and includes a processor 22, a display device 24, an input device 26 and a computer readable medium 28. The input device 26 is in communication with the processor 22 and is configured to input user data from a user to the processor. The input device 26 can be any suitable input device. The display device 24 is in communication with the processor 22 and is configured to be responsive to the processor to display images. The computer readable medium 28 includes one or more instructions executable by the processor 22. The system 20 is incorporated into a personal computer, but can be incorporated into any type of computer system. In the embodiment shown in FIGS. 3-8, the system 20 is a computer program running on a computer. The computer program is a customization of MICROSOFT ACCESS™ using the tools provided in that program. The program runs on a MICROSOFT WINDOWS™ operating system. One of ordinary skill in the art will recognize that the system could include a database program written in any suitable programming language configured to run on any suitable operating system on any suitable computer. The computer program generates screens displayed on the display device. Each screen is configured to convey information to the user and optionally to facilitate input from a user.

The system 20 is used to create a specific flavor formula. An example of a specific flavor formula is depicted in FIG. 2. A flavor formula is a recipe used by a flavorist to create a flavor. The flavor formula lists the ingredients included in the flavor and the amount of each ingredient that is added to an amount of at least one carrier to create the flavor. The carrier could be a solvent or some other type of liquid such as juice or water. Some ingredients are included in the flavor in such small quantities that an accurate measurement of the ingredient is problematic. For these small amounts a percent solution is used allowing a greater quantity of the percent solution to be measured and included for the desired amount of the ingredient in the flavor. For example, if one hundredth of a gram of an ingredient is needed, one tenth of a gram of a ten percent solution or one gram of a one percent solution of the ingredient could be used. A one hundred percent solution is the ingredient in a non diluted form.

The flavor formula can be scaled up according to need. Although the specific formula of FIG. 9 is in terms of grams, any suitable unit of measurement could be used. The amount of each ingredient is listed as a fraction (at the indicated solution strength under the % heading) of the total. If the total is to be increased by a multiple, each ingredient can be increased by the same multiple to create the flavor. As the amount of an ingredient is increased, the need to use a percent solution of the ingredient is reduced.

The system 20 is configured to store data. The data corresponds to a collection of ingredients and a collection of flavors for use in a flavor formula. The data may also correspond to a collection of descriptors. The data may also correspond to a collection of flavor profiles. A flavor profile is a description of an actual flavor. The description can correspond to list of descriptors describing the actual flavor. The system is also configured to store data corresponding to a flavor association and a sensory association. The flavor association associates at least one of the stored flavors with at least one of the stored ingredients. The flavor association may include additional flavor information such as a flavor classification. The flavor classification may be primary, secondary, or tertiary. The sensory association associates at least one sensory property with at least one stored ingredient. The sensory property includes at least one of a quantitative component and a qualitative component.

The system 20 is further configured to obtain user input corresponding to a selection of at least one of the stored flavors and to display at least one ingredient associated with the selected flavor. The system is further configured to display the stored sensory property associated by the sensory association with the displayed ingredient. The system may be further configured to display a flavor profile corresponding to the flavor selection. The system may be further configured to obtain user input corresponding to a use level of the displayed ingredient. The system may be further configured to create a flavor formula corresponding to the use level input by the user. The system may be further configured to save the flavor formula.

Referring now to FIGS. 3-8, an embodiment of the system is shown. The system includes a computer loaded with a computer program. FIG. 3 shows an ingredient screen (shown generally at 30) configured to allow a user to manage a collection of ingredients. An Add button 32 on this screen allows a user to add an ingredient to the collection of ingredients stored in the system. A Delete button 34 allows an ingredient to be removed from the collection of ingredients stored on the system. A Find button 36 allows a user to search for a desired ingredient. When adding an ingredient to the ingredient collection, the system is configured to store date corresponding to at least a name. The stored data may also include an ingredient number, a FEMA/FDA number, a supplier, and a prefix (not shown). The stored ingredient data can be input by the user manually using the input device. The stored ingredient data could also be automatically transferred from another database through the input device. For example, a list of FDA approved ingredients could be transferred directly from an FDA database such as a website.

FIG. 4 shows a descriptor screen (shown generally at 38) configured to allow a user to manage a collection of descriptors. An Add button 40 on this screen allows a user to add a descriptor to the collection of descriptors stored in the system. A Delete button 42 allows a descriptor to be removed from the collection of descriptors stored in the system.

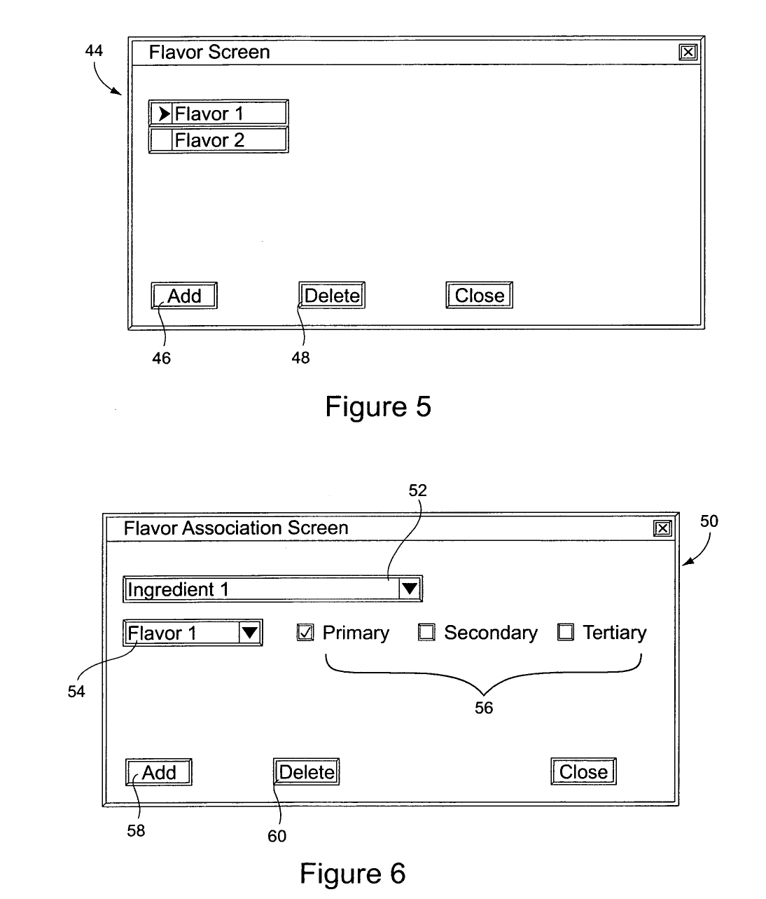

FIG. 5 shows a flavor screen (shown generally at 44) configured to allow a user to manage a collection of flavors. An Add button 46 on this screen allows a user to add a flavor to the collection of flavors stored in the system. A Delete button 48 allows a flavor to be removed from the collection of flavors stored on the system.

FIG. 6 shows a flavor association screen (shown generally at 50) configured to allow a user to manage a flavor association stored in the system. An ingredient drop down menu 52 displays the ingredients stored in the system. Selection of an ingredient in the ingredient drop down menu 52 selects the ingredient to which flavors will be associated. A flavor drop down menu 54 displays the flavors stored in the system. Selection of a flavor in the drop down menu associates the selected flavor with the selected ingredient. A flavor classification provides an additional association for the selected flavor of primary, secondary or tertiary. Selection of a box next to primary, secondary or tertiary selects the flavor classification for the flavor and the selected ingredient. A primary flavor classification indicates that the ingredient tastes like the flavor. A secondary flavor classification indicates that the ingredient could be a compliment to the flavor. A tertiary classification indicates that the ingredient could distinguish the flavor. An Add button 58 on this screen adds an additional flavor drop down menu 54. The added flavor drop down menu 54 can then be used as described above to add a flavor association to the selected ingredient. A Delete button 60 on this screen deletes a selected flavor from the flavors associated with the selected ingredient.

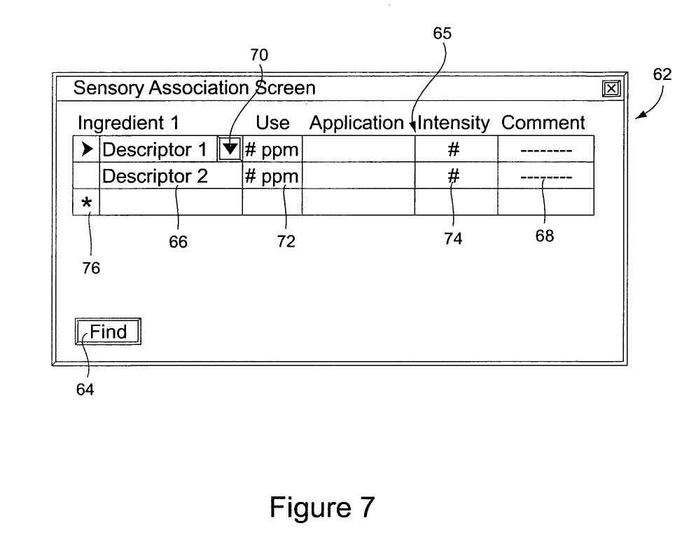

FIG. 7 shows a sensory association screen (generally at 62) configured to allow a user to manage a sensory association stored in the system. A Find ingredient button 64 displays the ingredients stored in the system. Selection of an ingredient selects the ingredient to which a sensory property will be associated. The sensory property is displayed generally at 65. The sensory property includes at least a qualitative component. The qualitative component can be a descriptor 66 selected from the collection of descriptors and/or a comment 68 recorded by a user. A descriptor drop down menu 70 displays the collection of descriptors stored on the system. Selection of a descriptor from the descriptor drop down menu selects a descriptor to associate with the ingredient. Selection of a comment field allows the user to enter a comment using the input device 26. The sensory property also includes a quantitative component. The quantitative component includes a use level 72 corresponding to an amount of the ingredient in an application. The application can be water, oil, solvent, or any other suitable application and indicates the medium carrying the ingredient when sampled. The quantitative component also includes an intensity value 74. The intensity value corresponds to the strength of the ingredient at the use level. The intensity value in the embodiment shown is selected from a scale of one to ten but can be selected from any scale of numbers. Additional sensory properties can be added to the sensory association by selecting an Add button 76.

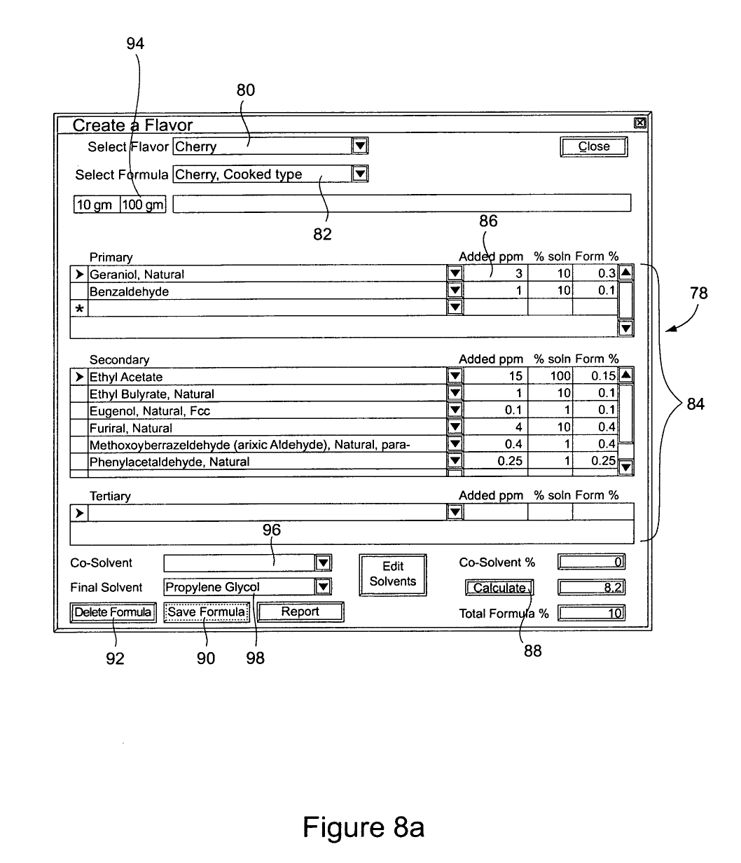

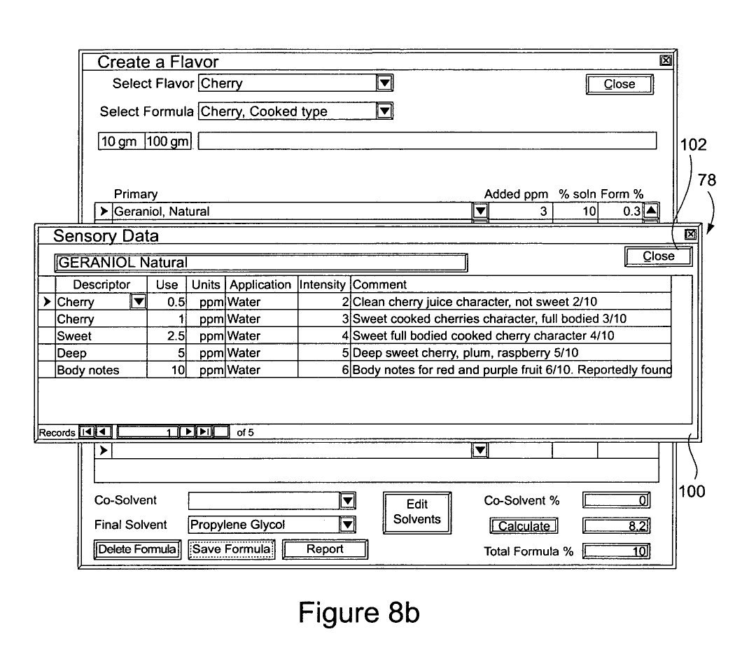

FIGS. 8a and 8b show a Create a Flavor screen generally at 78 in use to create a specific flavor formula. A flavor drop down menu 80 displays the flavors stored in the system. A formula drop down menu 82 displays specific flavor formulas that have been saved for a selected flavor from the flavor drop down menu 80. An ingredient portion 84 displays ingredients associated with the selected flavor from the flavor drop down menu 82. The displayed ingredients are grouped by flavor classification. A use level window 86 is located next to each displayed ingredient. A calculate button 88 calculates the percent solution and formula amounts for each displayed ingredient. A Save button 90 allows a user to save a formula as a specific flavor formula. A Delete button 92 allows a user to delete a formula. A ten/hundred gram button 94 allows the formula to be calculated for ten or one hundred grams. A Co-Solvent drop down menu 96 and a Final Solvent drop down menu 98 allow a user to select a co-solvent and a final solvent and to enter an amount to be used in the formula. Selection of a displayed ingredient opens a Sensory Data window 100. The Sensory Data window 100 displays sensory properties associated with the selected ingredient as shown in FIG. 8b. The Sensory Data window includes a Close button 102 that closes the Sensory Data window when selected.

The creation of a flavor formula is a subjective process. The taste of an item can differ from one flavorist to another. A flavorist relies on a lifetime of experience when creating a flavor. The system of FIG. 1 records and organizes the experiences of a flavorist. These experiences can subsequently be recalled by the flavorist to assist in the development of a new flavor. The process will still require the expertise of the flavorist, but a significant amount of trial and error can be eliminated. The use of the system is set forth below to demonstrate the process of creating a flavor formula and to illuminate the advantages of using the system. For purposes of discussion, the system used below initially has no stored data.

The FDA has approved a list of ingredients for use in a manufactured flavor. By using only FDA approved ingredients, a flavorist can ensure that a flavor formula can be used by others to create a food additive. A user starts the program and accesses the Ingredient screen 30 shown in FIG. 3. The user inputs a portion or all of the FDA approved ingredients. The user also accesses the Descriptor screen shown in FIG. 4 and inputs descriptors into the system. The user also accesses the Flavor screen shown in FIG. 5 and inputs flavors into the system. The process of inputting the ingredients, flavors and descriptors can be performed manually or it could be automated. The flavors and descriptors input into the system can reflect the user. For example, ethnic or geographic influences can be reflected in the flavors and descriptors. As a result, the system can be used by users having various backgrounds and even speaking different languages.

After the flavors, ingredients, and descriptors have been entered into the system, the user can input flavor associations and sensory associations to further customize the system. The user must determine the flavors to associate with a particular ingredient by tasting the ingredient. The flavor association screen 50 is accessed and the particular ingredient is selected. The user then selects a flavor from the flavor drop down menu 54 to associate with the particular ingredient. The user also assigns a flavor classification in the flavor classification section 56. The Sensory association screen 62 is accessed and the particular ingredient is selected using the Find ingredient button 64. A sensory property is input into the system. The user inputs the use level and the application in which the particular ingredient was tasted. The qualitative portion of the sensory property includes a descriptor 66 selected from the descriptor drop down menu 70 and optionally a comment 68 describing the ingredient at that use level. The quantitative portion of the sensory property includes an intensity value 74. The intensity value relates to the level of perception of the ingredient at the use level. The intensity value is quantitative because while flavorists may differ on their interpretation of the taste, the intensity of an ingredient at a use level can be agreed upon. For example, two flavorists can sample an ingredient at a use level and select different descriptors to describe the taste, but the flavorists will generally choose the same intensity value to describe the perception of the taste at that level. The particular ingredient is prepared at another use level and the user re-samples the particular ingredient and repeats the process of inputting a sensory property. This re-sampling process is repeated as necessary for the particular ingredient and the entire process is repeated as necessary for the remaining ingredients. The user's experience and personal perceptions will be reflected in the resulting flavor associations and sensory associations. A flavorist with twenty years of experience may have more flavors associated with a particular ingredient than a flavorist with two years of experience. Similarly, an experienced flavorist may be able to discern more distinctions of an ingredient at different use levels than a relatively inexperienced flavorist. Again, the system reflects the cumulative experience of the user responsible for inputting the above information. The system 20 allows the input data described above to be modified, supplemented or eliminated as needed by the user.

After the above information is entered, the system 20 can be used to create a flavor formula. Referring to FIGS. 8a and 8b, the process of creating a specific flavor formula will be explained. The Create a Flavor screen 78 has been accessed by the user to create a specific flavor formula saved as “Cherry, Cooked type” that is displayed in FIG. 8a. “Cherry” has been selected from the flavor pull down menu 80. A list of formulas that started as cherry flavor and that were subsequently saved as a specific flavor formula are displayed in the formula pull down menu 82. The formula pull down menu 82 includes a selection for “create a new formula” (not shown). Selection of the “create a new formula” displays all of the ingredients that have been associated with the selected flavor (from the flavor pull down menu 80) by the flavor association. The ingredients are organized in the ingredient portion 84 by flavor classification into primary, secondary and tertiary classifications. Selection of a displayed ingredient displays, in the Sensory Data window 100 of FIG. 8b, the sensory properties associated by the sensory association with the selected ingredient. The user can then review the sensory properties to determine a use level of the ingredient to be entered in the use level window 86. This process is repeated until finished.

In the specific flavor formula shown in FIG. 8a, the user has entered 3 ppm in the use level window 86 for the ingredient Geraniol. The system 20 provided the Sensory Data associated with the ingredient Geraniol to allow the user to determine the use level. Selection of Geraniol in FIG. 8a displays the Sensory Data window 100 shown in FIG. 8b. The Sensory Data window displays the sensory properties for Geraniol entered by the user. The user can refer to these sensory properties when determining a use level. In this case, the user chose a use level of 3 ppm and thus it can be inferred that the user desired something between the sensory properties listed for 2.5 ppm and 5 ppm. Using the qualitative components the user could see that the descriptors ranged from Sweet to Deep and the comments indicated a sweet full bodied cooked cherry character to a deep sweet cherry, plum, raspberry for the ingredient between 2.5 and 5 ppm. Using this information alone the user could have selected the use level of 3 ppm entered into the use level window 86. The sensory data also indicates a quantitative component. Geraniol has an intensity of 4 at 2.5 ppm and 5 at 5 ppm. The user could have selected a use level of 3 ppm because an intensity slightly more than 4 was desired for this ingredient. This process was repeated for each of the displayed ingredients. After a use level had been entered for each of the ingredients in the use level window 86, the user selected the Calculate button 88. The use levels were entered in parts per million but could also have been entered in parts per billion. The program automatically determined the actual amount of the ingredient in the formula from the use level for the ingredient. The actual amount included a percent solution of the ingredient and the formula amount in grams of that solution to be added. The actual amount included a formula amount of percent solution that could be feasibly measured. The formula amount should not be smaller than a tenth of a gram. The program defaults to a more dilute percent solution if necessary to ensure a formula amount of more than a tenth of a gram. Finally, the amount of solvent to be added was calculated (the sum of the actual amounts less the total formula amount) to complete the formula. The amount of solvent could have included a co-solvent if desired. A use level for a particular ingredient can be adjusted and the formula will be automatically adjusted to accommodate the change. The Save button 90 allowed the user to save the created formula as “Cherry, Cooked type” that subsequently appeared in the formula drop down menu 82.

Another feature of the system is to allow a user to view a stored flavor profile and to compare the flavor profile with a specific flavor formula. The flavor profile contains a description of an actual flavor. If the flavor profile suggests a descriptor that is not reflected in the specific flavor formula, the user can return to the flavor association screen and add the flavor to the flavor association for ingredients suggested by the flavor profile. This is especially helpful in identifying secondary and tertiary flavor classifications for an ingredient. For example, the flavor profile for banana may include a description including an earth taste. The flavorist can access those ingredients having a primary flavor classification of earth taste and then add a secondary or tertiary flavor classification to those ingredients for banana. The flavor profile allows the system to incorporate this new information and possibly produce flavor formulas that create more realistic flavors.

In the embodiment of shown in the drawings the system is embodied in a computer running a program. However, it is to be understood that other devices can embody the system without departing from this invention. For example, the device could be part of a network with the components separated spatially. In addition, the system could be adapted to create a fragrance formula by substituting the sense of smell for the sense of taste. The system would not change but the data stored would represent different information.

As various changes could be made to the system without departing from the scope of the invention, it is intended that all matter contained in the above description or shown in the accompanying drawings shall be interpreted as illustrative and not in a limiting sense. Thus, the breadth and scope of the present invention should not be limited by any of the above-described exemplary embodiments, but should be defined only in accordance with the following claims appended hereto and their equivalents.

What is claimed is:

1. A system for creating a flavor formula, the system comprising:
a processor;
an input device in communication with the processor, the input device being configured to input user data from a user to the processor;
a display device in communication with the processor, the display device being configured to be responsive to the processor to display images thereon;
a computer readable medium having one or more instructions executable by the processor for (1) storing data, the data comprising: data corresponding to an ingredient; data corresponding to a plurality of flavors; data corresponding to a flavor association of at least one of the stored flavors with at least one of the stored ingredients, the flavor association data being created in response to user input; data corresponding to a sensory association of at least one sensory property with at least one stored ingredient, the sensory property including at least one of a quantitative component and a qualitative component and being created in response to user input; (2) obtaining user input corresponding to a selection of at least one of the stored general flavors; (3) displaying on the display device at least one ingredient associated with the flavor selection based on the stored flavor association; (4) displaying on the display device the stored sensory property for the displayed ingredient.

2. A system as set forth in claim 1 wherein the sensory property includes a qualitative component.

3. A system as set forth in claim 1 wherein the sensory property includes a quantitative component and a qualitative component.

4. A system as set forth in claim 1 wherein the stored data further comprises data corresponding to a descriptor.

5. A system as set forth in claim 1 wherein the stored data further comprises data corresponding to a flavor profile.

6. A system as set forth in claim 5 wherein the computer readable medium further comprises one or more instructions for displaying on the display device a flavor profile corresponding to the flavor selection.

7. A system as set forth in claim 1 wherein the computer readable medium instructions further comprise one or more instructions for obtaining user input corresponding to a use level of the ingredient input and being created in response to user input.

8. A system as set forth in claim 7 wherein the computer readable medium instructions further comprise one or more instructions for creating a specific flavor formula corresponding to the use level of the ingredient input by the user.

9. A system as set forth in claim 7 wherein the use level is in parts per million.

10. A system as set forth in claim 8 wherein the specific flavor formula includes an actual amount of the ingredient corresponding to the use level of the ingredient input by the user.

11. A system as set forth in claim 10 wherein the actual amount is a solution amount, the solution amount being a percent solution of the ingredient.

12. A system as set forth in claim 1 wherein the stored flavor association data includes a flavor classification, the flavor classification being selected from the group consisting of primary, secondary, and tertiary.

13. A method of creating a specific flavor formula using a flavor creation system, the flavor creation system including a processor, an input device in communication with the processor, the input device being configured to input user data from a user to the processor, a display device in communication with the processor, the display device being configured to be responsive to the processor to display images thereon, and a computer readable medium having one or more instructions executable by the processor for (1) storing data, the data comprising: data corresponding to an ingredient; data corresponding to a plurality of flavors; data corresponding to a flavor association of at least one of the stored flavors with at least one of the stored ingredients, the flavor association data being created in response to user input; data corresponding to a sensory association of at least one sensory property with at least one stored ingredient, the sensory property including at least one of a quantitative component and a qualitative component and being created in response to user input; (2) obtaining user input corresponding to a selection of at least one of the stored flavors; (3) displaying on the display device at least one ingredient associated with the flavor selection based on the stored flavor association; (4) displaying on the display device the stored sensory property for the displayed ingredient, the method comprising the steps of:
selecting a flavor from the stored flavors;
displaying an ingredient associated by the flavor association with the selected flavor;
displaying a sensory property associated by the sensory association with the displayed ingredient; and
inputting a use level of the ingredient.

14. A method as set forth in claim 13 wherein the displaying a sensory property step further comprises displaying a sensory property associated by the sensory association with the displayed ingredient wherein the sensory property includes a qualitative component.

15. A method as set forth in claim 13 wherein the displaying a sensory property step further comprises displaying a sensory property associated by the sensory association with the displayed ingredient wherein the sensory property includes a quantitative component and a qualitative component.

16. A method as set forth in claim 13 wherein the displaying an ingredient associated with the selected flavor by the flavor association further comprises displaying a plurality of ingredients associated with the selected flavor by the flavor association, the plurality of ingredients being displayed by flavor classification.

17. A method as set forth in claim 13 further comprising for each of the plurality of ingredients: repeating the steps of displaying the sensory property and inputting a use level.

18. A method as set forth in claim 13 wherein the inputting a use level step further comprises inputting a use level in parts per million.

19. A method as set forth in claim 18 further comprising:
converting the use level from parts per million to an actual amount.

20. A method as set forth in claim 19 wherein the actual amount is a solution amount, the solution amount being a percent solution of the ingredient.

21. A method as set forth in claim 13 further comprising:
creating a specific flavor formula corresponding to the input use level of the ingredient.

22. A method as set forth in claim 21 further comprising:
saving the specific flavor formula.

23. A method of selecting an input level of an ingredient in a flavor formula, the method comprising:
displaying a sensory property of the ingredient, the sensory property including at least one of a qualitative component and a quantitative component; and
using the sensory property of the ingredient to determine the input level of the ingredient in the flavor formula.

24. A method as set forth in claim 23 wherein the sensory property comprises a qualitative component.

25. A method as set forth in claim 23 wherein the sensory property comprises a qualitative component and a quantitative component.

26. A method as set forth in claim 23, wherein the sensory property comprises a qualitative component and a quantitative component, the quantitative component being at least one intensity number, the intensity number being a number from an intensity scale, the intensity scale corresponding to the perception of the ingredient at a use level.
